(19) United States
(12) Patent Application Publication
(10) Pub. No.: US 2023/0136016 A1
(43) Pub. Date: May 4, 2023

(54) SYSTEMS, DEVICES, AND METHODS FOR A DIGITAL ANALOG HYBRID HAPTIC EFFECTS CONTROLLER

(71) Applicant: IMMERSION CORPORATION, San Francisco, CA (US)

(72) Inventor: Juan Manuel CRUZ HERNANDEZ, Montreal (CA)

(21) Appl. No.: 17/432,171

(22) PCT Filed: Feb. 21, 2020
(86) PCT No.: PCT/US2020/019187

§ 371 Date: Aug. 19, 2021

Related U.S. Application Data
(60) Provisional application No. 62/810,174, filed on Feb. 25, 2019.

(51) Int. Cl. G06F 3/01

(52) U.S. Cl. CPC G06F 3/016

(57) ABSTRACT

A haptically enabled device including a digital-analog hybrid control circuit is provided. The digital-analog control circuit includes an analog control circuit and at least one processor and is configured to control a vibration actuator to produce a limited duration haptic effect. The digital-analog control circuit receives a motion characteristic feedback signal from a sensor and uses the motion characteristic feedback signal to provide continuous adjustment to a command signal that controls the vibration actuator.

### RELATED APPLICATIONS

This application claims the benefit of prior U.S. Application 62/810,174, filed on Feb. 25, 2019, the entire contents of which are incorporated by reference herein.

### FIELD OF THE INVENTION

The present invention relates to systems, devices and methods for providing haptic effects of limited duration. In particular, the present invention is directed to providing techniques for closed loop feedback control of vibration actuators to produce well defined haptic effects of limited duration using a digital-analog hybrid controller.

### BACKGROUND OF THE INVENTION

Haptic actuators for producing vibration effects, i.e., vibration actuators such as eccentric rotating masses, linear resonant actuators, piezo based actuators, etc., are conventionally used in haptically enabled devices to provide vibration effects of moderate to long durations. Such haptic effects present to a user as buzzing or vibrating sensations. Providing a buzzing sensation can be implemented through excitation of a vibration actuator for many, e.g., dozens, hundreds, or even thousands of oscillations. Such vibration effects are implemented through conventional open loop control techniques of the vibration actuators. Precise actuator control over limited durations in these circumstances is not required and would introduce unnecessary costs in device manufacture.

In some circumstances, it may be desirable to produce haptic effects of limited duration, wherein a vibration actuator undergoes only a few, e.g., less than ten, oscillations. Such haptic effects may present to a user as clicks rather than buzzes. These types of clicks may be desirable, for example, to provide the sensation and satisfaction of a mechanical response to a touchscreen input. Conventionally, open loop control techniques and hardware are adapted to provide these short duration clicks by, for example, implementing actuator braking. To retain a high-quality well-defined sensation with a sharp edge through open loop braking may require good actuator characterization. Deviation in the actuator from the characteristics of the open loop control scheme can result in an effect that trails off rather than ends sharply. Thus, for example, variance from a specified resonant frequency of a linear resonant actuator can result in degraded limited duration haptic effects. Conventional solutions to this problem include post manufacture characterization of actuator outputs and adjustment of open loop control parameters.

Inventions described herein provided improved methods of generating limited duration haptic effects in haptically enabled devices.

### BRIEF SUMMARY OF THE INVENTION

Systems, devices, and methods are provided herein to accommodate closed loop feedback control of vibration actuators to produce precise haptic vibration effects of limited duration. Heretofore, closed loop feedback control has not been applied to vibration actuators because it is believed that conventional vibration effects do not require precise control. Conventional haptically enabled devices also do not include the necessary components for closed-loop control and the introduction of such components is believed to unnecessarily increase the cost of such devices. Digital-analog hybrid control systems described herein serve to inexpensively provide precise closed loop control to haptically enabled devices.

Embodiments hereof may include sensors, control circuits, and vibration actuators specifically configured to provide closed loop control capabilities for the production of limited duration vibration effects. Embodiments further may include devices and systems incorporating these components as well as methods of implementing closed-loop control techniques to provide limited duration haptic effects.

Embodiments hereof include a haptically enabled device. The haptically enabled device includes a vibration actuator; a sensor, configured to measure a motion characteristic of the vibration actuator, and to output a motion characteristic feedback signal; a digital-analog hybrid control circuit comprising an analog control circuit and at least one processor configured to control the vibration actuator to produce a limited duration haptic effect. The digital-analog hybrid controller is configured to control the vibration actuator by: generating a reference signal representing the limited duration haptic effect at the processor, providing an error signal to the analog control circuit, providing, by the analog control circuit, a command signal to the vibration actuator based on the error signal, sampling the motion characteristic feedback signal, and providing continuous adjustment of the error signal, by the processor, at the sampling frequency according to the motion characteristic feedback signal and the reference signal to cause the analog control circuit to continuously adjust the command signal to minimize an error between the reference signal and the motion characteristic feedback signal.

Further embodiments include a method of controlling a vibration actuator by a digital-analog hybrid control circuit comprising an analog control circuit and a processor to produce a limited duration haptic effect. The method includes generating, by the processor, a reference signal, the reference signal representing the limited duration haptic effect. The method further includes providing, by the processor, an initial error signal to the analog control circuit to cause the analog control circuit to generate a command signal for activating the vibration actuator; measuring, by a sensor over time, a motion characteristic of the vibration actuator; outputting, by the sensor, a motion characteristic feedback signal indicative of the motion characteristic; and controlling the vibration actuator to provide the limited duration haptic effect. Controlling the vibration actuator includes sampling, by the processor, the motion characteristic feedback signal, and providing continuous adjustment of the error signal, by the processor, at the sampling frequency according to the motion characteristic feedback signal and the reference signal while providing a command signal by the analog control circuit, wherein providing continuous adjustment of the error signal causes the analog control circuit to continuously adjust the command signal to minimize an error between the reference and the motion characteristic feedback signal.

### BRIEF DESCRIPTION OF DRAWINGS

The foregoing and other features and advantages of the invention will be apparent from the following description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a schematic diagram illustrating aspects of a haptically enabled device in accordance with embodiments hereof.

FIGS. 2A and 2B are schematic diagrams illustrating a digital-analog hybrid control circuit implemented via an integrated circuit according to embodiments hereof.

FIG. 3 is a flow chart of an actuator control process consistent with embodiments hereof.

FIGS. 4A and 4B are charts showing results of LRA testing consistent with embodiments hereof.

### DETAILED DESCRIPTION OF THE INVENTION

Specific embodiments of the present invention are now described with reference to thefigures. The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Embodiments described herein relate to haptically enabled devices. Haptically enabled devices consistent with embodiments herein may be configured as smartphones, tablet computing devices, smart watches, fitness bands, haptic enabled wearable devices, glasses, virtual reality (VR), augmented reality (AR), and/or mixed reality (MR) headsets, handheld gaming devices, personal computers (e.g., a desktop computer, a laptop computer, etc.), televisions, interactive signs, and/or other devices that can be programmed to provide a haptic output to a user. Haptically enabled devices consistent with embodiments hereof include devices having one or more vibration actuators for delivering vibration effects to the haptically enabled device. In embodiments hereof, haptically enabled devices may also include user input elements, e.g., control elements such as triggers, buttons, joysticks, joypads, touchscreens, touchpads, etc., to permit a user to interact with a computer system. Haptically enabled devices may further include peripheral devices configured to augment the capabilities of other devices, haptically enabled or not.

Haptically enabled devices consistent with embodiments hereof may include processing systems. Processing systems consistent with embodiments described herein include one or more processors (also interchangeably referred to herein as processors, processor(s), or processor for convenience), one or more memory units, audio outputs, user input elements, a communication unit or units, and/or other components. Processors may be programmed by one or more computer program instructions to carry out methods described herein. Communication units consistent with the present invention may include any connection device, wired or wireless, that may transmit or communicate with peripheral devices.

In embodiments hereof, haptically enabled devices may be provided separately from processing systems configured to provide haptic control signals to the haptically enabled device. Such haptically enabled devices include vibration actuators and the required control circuity and power sources to activate the vibration actuators. Haptically enabled devices provided separately from processing systems may be, for example, wearable devices intended for communication with a central processing system. Haptically enabled devices according to these embodiments may include wrist-bands, rings, leg-bands, finger attachments, gloves, eye-glasses, and other types of devices configured to provide haptic outputs.

Embodiments hereof relate to closed-loop feedback control of vibration actuators via digital-analog hybrid controllers to produce haptic effects of limited duration. Feedback control systems consistent with embodiments hereof are configured to reduce and/or minimize errors between intended haptic effects, represented by a reference signal, and an output haptic effect, represented by a motion characteristic signal. Reference signals represent haptic effects intended to be produced by vibration actuators. In response to the reference signals, feedback control systems as described herein control haptic outputs, which are measured by sensors outputting motion characteristic signals. The motion characteristic signals are used by the feedback systems to minimize errors in the haptic output.

As used herein “vibration actuator” refers to an actuator configured to produce a haptic effect by oscillation or vibration in response to a command signal. Vibration actuators consistent with embodiments hereof are capable of producing haptic effects by oscillating or vibrating at 1 Hz or more. Haptic effects of limited duration refer to haptic effects having a duration of less than 100 ms. The length of a limited duration haptic effect may change according to the frequency of actuator. For example, one oscillation of an actuator at 10 Hz requires 100 ms, and a limited duration haptic effect may be 100 ms or less. In contrast, at 1,000 Hz, one oscillation requires just 1 ms, and a limited duration haptic effect may encompass 15 oscillations, taking approximately 15 ms. In embodiments, limited duration haptic effects may have durations less than 100 ms, less than 50 ms, 30 ms, less than 25 ms, less than 20 ms, and/or less than 15 ms. In embodiments, limited duration haptic effects may employ vibration actuators operating between 1 Hz and 1000 Hz for durations between 15 ms and 50 ms. Selection of limited duration haptic effect durations may be performed based on the type of actuator being used, the amount of force or displacement provided by the vibration actuator, and/or by the type of effect that is sought by the designer. In embodiments, the duration of the limited duration haptic effect may be determined according to a representative transient time of the vibration actuator producing the haptic effect. Limited duration haptic effects may be produced by a vibration actuator performing anywhere between 1 and approximately 15 oscillations, where the number of oscillations delivered may be selected according to the frequency of the vibration actuator. Embodiments hereof further relate to closed-loop feedback control of vibration actuators to produce sharp haptic effects of limited duration. As used herein, “sharp haptic effects” refers to haptic effects having an abrupt cut-off at the completion of the effect.

In embodiments, vibration actuators consistent with embodiments hereof may include macrofiber composite actuators, capable of producing vibration effects at frequencies between 1 Hz and 10,000 Hz. In further embodiments, vibration actuators consistent with embodiments hereof may include piezoelectric material based vibration actuators, such as piezoceramic actuators, capable of producing vibration effects at frequencies between approximately 1 Hz and 10,000 Hz. In further embodiments, vibration actuators consistent with embodiments hereof may include LRAs, capable of producing vibration effects at frequencies between approximately 50 Hz and 500 Hz. Other types of vibration actuators, such as ERM actuators, configured to deliver haptic effects through vibrating components in the frequency range of 1 Hz and 10,000 Hz may be employed with embodiments hereof.

Some vibration actuators consistent with embodiments hereof, such as LRAs, are designed to provide a resonant response to a frequency input, and frequently have a high Q-factor or narrow bandwidth. Such actuators are constructed to minimize damping to provide greater efficiency. Thus, when provided with a command signal at the resonant frequency of the vibration actuator the vibration haptic response is maximized. To prevent wasted energy, such actuators are constructed to minimize friction and other sources of damping. When a command signal to the vibration actuator is ceased, the vibration actuator will still oscillate several times at its resonant frequency. Creating a strong haptic effect requires a commensurately powerful signal which, without damping, will cause the vibration actuator to oscillate several times before slowing to a stop. For conventional uses of vibration actuators, this is an acceptable result, as tens of milliseconds of free oscillations after cessation of a command signal does not degrade a vibration or buzzing haptic effect of several hundred milliseconds. On the contrary, tens of milliseconds of free oscillations will significantly distort an intended 15 millisecond haptic effect.

Closed loop control of vibration actuators that oscillate at high frequencies requires high frequency measurements of the motion of such actuators as well as high frequency control schemes. An actuator oscillating at 1000 Hz cannot be reliably controlled by a control scheme providing commands at 500 Hz. Conventional mobile devices are typically not equipped with digital signal processing circuitry sufficient to implement digital control schemes at a high frequency. While processing units specifically tailored for high frequency digital control exist, the addition of such to a mobile device may represent an unacceptable increase in expense for the mobile device.

Embodiments herein describe the use of hybrid digital-analog control systems configured to provide high-frequency control through the use of dedicated analog integrated circuits in combination with digital processing units. Digital processing units consistent with embodiments hereof may include the central processing units of mobile devices. Accordingly, high frequency closed loop control schemes may be added to haptically enabled devices inexpensively.

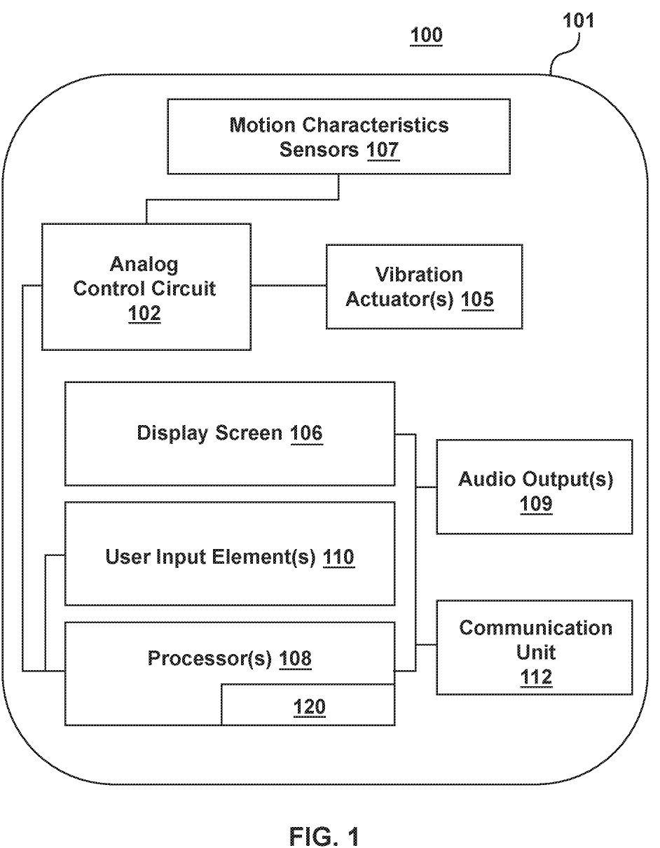

FIG. 1 is a schematic diagram illustrating aspects of a haptically enabled device 100 in accordance with embodiments hereof. The haptically enabled device 100 includes one or more vibration actuators 105, an analog control circuit 102, one or more motion characteristic sensors 107, and a housing 101. Optionally, the haptically enabled device 100 further includes a display 106, at least one processor 108, at least one memory unit 120, one or more user input elements 110, one or more audio outputs 109, and one or more communication units 112.

The vibration actuators 105 include actuators configured for oscillation or vibrate in response to a command signal. Vibration actuators 105 are configured to produce haptic effects when oscillating at frequencies in excess of 50 Hz. Vibration actuators 105 may include actuators configured with a spring-mass oscillatory system, such as linear resonant actuators (LRAs) and voice coil actuators. Vibration actuators 105 consistent with embodiments hereof are configured to produce oscillatory effects ranging between approximately 50 Hz and 1000 Hz.

Motion characteristic sensors 107 include sensors and transducers configured to measure motion. Motion characteristic sensors 107 are configured to measure a motion characteristic of the vibration actuator 105 of the haptically enabled device 100. Motion characteristic sensors 107 include sensors configured to determine motion characteristics of actuator components. Such motion characteristics may include, for example, vector values such as displacement, force, velocity, momentum, angular velocity, angular momentum, and acceleration as well as scalar values such as speed, distance, and acceleration magnitude. Other motion characteristics may include oscillatory characteristics such as frequency, amplitude, and phase. In embodiments, direct measurement of one or more of the above motion characteristics may be used to determine values for other motion characteristics. For example, direct measurement of acceleration may be used to indirectly determine velocity and/or displacement. In some examples, system parameters may be stored in a memory for use in such determinations. For example, a system’s mass may be stored as a parameter and combined with a measurement of acceleration to permit a determination of force. In an example of a motion characteristic sensor 107, the motion characteristic sensor 107 is configured to determine motion characteristics of a moving mass of a vibration actuator 105. In another example, a motion characteristic sensor 107 is configured to measure strain of a spring associated with a spring-mass actuator system.

The motion characteristic sensor 107 may be, for example, an accelerometer. A motion characteristic sensor 107 may be implemented as an accelerometer and/or may be a transducer specifically selected for detecting motion characteristics of the vibration actuator 105 and/or may be a transducer included within the haptically enabled device 100 for other purposes. For example, haptically enabled devices 100 frequently include accelerometers for tilt-control or step-counting purposes. Such an accelerometer may provide motion characteristics information as a motion characteristic sensor 107. In optional embodiments, a motion characteristic sensor 107 implemented as an accelerometer is oriented to detect motion in the same axis of movement as the vibration actuator 105 is oriented to produce movement.

An analog control circuit 102 for use in an embodiment hereof may be a collection of components configured for controlling the vibration actuators 105. In embodiments, a control circuit 102 may include an integrated circuit containing components dedicated to providing the haptic control functionality. For example, the control circuit 102 may include an application specific integrated circuit (“ASIC”), a programmable gate array (“PGA”), a field programmable gate array (“FPGA”), system on a chip (“SoC”), or other type of integrated circuit. In further embodiments, the control circuit 102 may be implemented entirely in hardware components and may include various electronics components, e.g., capacitors, resistors, op-amps, etc., configured to perform the functionality discussed herein.

Optional components of the haptically enabled device 100 further include a display 106, at least one processor 108, at least one memory unit 120, user input elements 110, audio outputs 109, and one or more communication units 112.

The haptically enabled device 100 may include one or more processors 108 and one or more memory units 120. The processors 108 may be programmed by one or more computer program instruction stored in the memory unit(s) 120. The functionality of the processor 108, as described herein, may be implemented by software stored in the memory unit(s) 120 or another computer-readable or tangible medium, and executed by the processor 108. As used herein, for convenience, the various instructions may be described as performing an operation, when, in fact, the various instructions program the processors 108 to perform the operation.

The various instructions described herein may be stored in the memory unit(s) 120, which may comprise random access memory (RAM), read only memory (ROM), flash memory, and/or any other memory suitable for storing software instructions. The memory unit(s) 120 may store the computer program instructions (e.g., the aforementioned instructions) to be executed by the processor 108 as well as data that may be manipulated by the processor 108.

The processor 108 is configured to operate in conjunction with the analog circuit 102 to provide closed loop control of the vibration actuators 105 as a digital-analog hybrid controller, as discussed in greater detail below.

User input elements 110 for use with embodiments hereof may include any elements suitable for accepting user input. These may include buttons, switches, dials, levers, touchscreens, touchpads, and the like. The user input elements 110 may further include peripherally connected devices, such as mice, joysticks, game controllers, keyboards, and the like. User input elements 110 may further include cameras, radar devices, lidar devices, ultrasound devices, and other devices configured to remotely capture user gestures.

A communication unit 112 in accordance with embodiment hereof may include one or more devices or components configured for external communication. The communication unit may include wired communication ports, such as USB ports, HDMI® ports, A/V ports, optical cable ports, and any other component or device configured to receive or send information in a wired fashion. The communication unit may further include wireless communication devices, such as BLUETOOTH® antennas, WI-FI® antennas, cellular antennas, infrared sensors, optical sensors, and any other device configured to receive and/or transmit information wirelessly. In further embodiments, the communication unit 112 may include ultrasound speakers and microphones configured to transmit information via ultrasonic soundwaves.

A display 106 for use with embodiments hereof maybe a screen for providing a visual output to a user. The display 106 may include touchscreen capabilities (and therefore serve as a user input element 110 as well). The display 106 may be of any size, shape, or configuration to fit the needs of the haptically enabled device 100. In some embodiments of haptically enabled device 100, such as a wearable device configured for delivering haptic effects, no display 106 is required. In embodiments, the display 106 may include a head-mounted display, such as a VR, AR, or MR headset, goggles, and/or other VR/AR/MR display device. In embodiments, the display 106 may be projected, either onto a surface or for display in the air.

Audio outputs 109 include devices configured to provide an audio output to a user. Audio outputs 109 may include speakers as well as audio output ports, such as headphone jacks, configured for delivering an audio signal to a speaker or headphones. Audio outputs 109 may further include any hardware and/or antennas necessary for wireless transmission of audio signals, for example, via Bluetooth protocol.

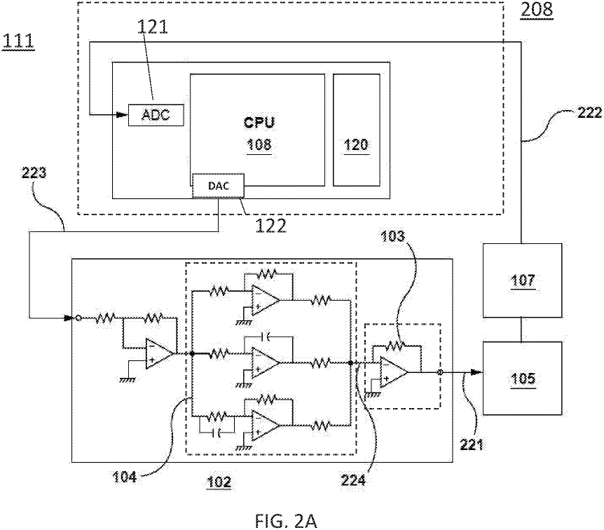

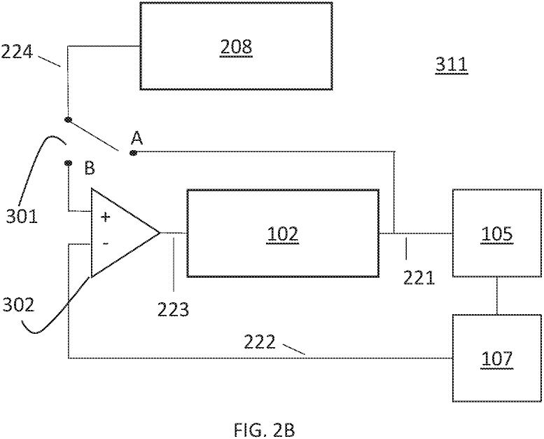

FIGS. 2A and 2B illustrate digital-analog hybrid control systems consistent with embodiments hereof. FIG. 2A illustrates a digital-analog hybrid control system 111 consistent with embodiments hereof. The digital-analog hybrid control system 111 includes an analog control circuit 102 and a digital control circuit 208. The digital control circuit 208 includes at least a processor 108, memory unit 120. The digital-analog hybrid control system 111 further includes an analog to digital converter (ADC) 121 and a digital to analog converter (DAC) 122. As shown in FIG. 2A, the ADC 121 and DAC 122 may be part of the digital control circuit 208. The ADC 121 and DAC 122 may be separate components and/or may have their functionality included as part of the processor 108. In further embodiments, the ADC 121 and DAC 122 may be part of the analog control circuit 102 and/or may not be included in either the analog control circuit 102 or digital control circuit 208. The analog control circuit 102 and the digital control circuit 208 cooperate to provide high frequency control of the vibration actuator 105 so as to produce haptic effects of limited duration.

The analog control circuit 102 is implemented as an integrated circuit in FIG. 2A. As illustrated in FIG. 2A, the analog control circuit 102 is an integrated circuit configured as a PID controller. The illustrated embodiment of the analog control circuit 102 is by way of example only and additional or different analog circuit components and controller schemes may be used without departing from the invention.

The processor 108 receives or generates a reference signal. The reference signal represents a desired haptic output. The reference signal is a time-varying signal that represents desired values of a motion characteristic measured over time. The reference signal may be a time-varying signal of any motion characteristic, including each of those discussed herein. For example, the reference signal may be an acceleration over time. The reference signal may represent the desired motion characteristics of the vibration actuator 105. In embodiments, the reference signal may represent a desired motion characteristic of a different component of the haptically enabled device 100 that is coupled to the vibration actuator 105. The reference signal may be generated by the processor 108 of the haptically enabled device 100, received from the at least one memory unit 120, and/or may be received from a source external to the haptically enabled device 100. For example, where the haptically enabled device 100 is implemented as a wearable device, such as a bracelet, for providing haptic effects, the reference signal may be delivered to the processor 108 from a processor of a larger system with which the wearable device is associated. In embodiments, the reference signal may track the same parameter as the motion characteristic sensor 107, e.g., the reference signal may indicate a desired acceleration over time when the motion characteristic sensor 107 is an accelerometer. In further embodiments, the reference signal may track a different parameter form the motion characteristic sensor 107. For example, the reference signal may indicate a desired velocity over time when the motion characteristic sensor 107 is an accelerometer.

The processor is configured to receive a motion characteristic feedback signal 222 from the motion characteristic sensor 107. The motion characteristic feedback signal 222 is converted from an analog signal to a digital signal by the ADC 121. The motion characteristic sensor 107 is configured to detect, measure, and/or determine at least one motion characteristic of the vibration actuator 103 and deliver the motion characteristic feedback signal 222 based on the motion characteristic to the processor 108. As discussed above, the motion characteristic sensor 107 may deliver a motion characteristic feedback signal 222 based on a directly measured motion characteristic, e.g., an acceleration measured by an accelerometer, and/or may deliver a motion characteristic feedback signal 222 derived from a measured motion characteristic, e.g., a velocity signal derived from an acceleration measured by an accelerometer. The motion characteristic feedback signal 222 may also be based on motion measurement of a part of the haptically enabled device 100 that is coupled to the vibration actuator 105. Once received, the motion characteristic feedback signal 222 is converted from an analog signal to a digital signal for processing by the processor 108.

The processor 108 receives (or generates) the reference signal and receives the motion characteristic feedback signal 222 and outputs the error signal 223 to the analog control circuit 102. The processor 108 compares the reference signal to the motion characteristic feedback signal 222 to determine an error between them. Based on the error, the processor 108 generates a digital error signal that is converted by the DAC 122 to analog error signal 223 that is then delivered to the analog control circuit 102.

The analog control circuit 102 receives the error signal 223. A control portion 104 of the analog control circuit 102 acts as a PID controller on the error signal 223 to produce an unamplified command signal 224. The unamplified command signal 224 of the control portion 104 is amplified by an amplifier portion 103 to produce a command signal 221.

The command signal 221 is output to the vibration actuator 105 to cause a haptic output. As the vibration actuator 105 is driven by the command signal 221, the haptic output of the vibration actuator 105 is measured by the motion characteristic sensor 107.

The processor 108 receives the motion characteristic feedback signal 222 and compares it to the reference signal to continuously adjust the error signal 223, and thus the command signal 221 that is output to the vibration actuator 105, to minimize the error between the reference signal and the motion characteristic feedback signal 222.

As used herein, continuous adjustment means that a signal output by the processor 108, e.g., the error signal 223, is adjusted on an ongoing basis during the output of that signal to adjust a haptic effect or output. For digital applications, it is understood that continuous adjustment includes repeated discrete adjustments. Continuous adjustment, as used herein, does not include the use of measurements of haptic outputs for use in the adjustment of parameters for future haptic effects, even if performed on a regular basis. In embodiments, continuous adjustment may be performed digitally at frequencies in excess of 500 Hz, in excess of 1 kHz, 5 kHz, 10 kHz, and 20 kHz. In embodiments, the motion characteristic feedback signal 222 is sampled at a frequency equal to or in excess of the continuous adjustment frequency. In embodiments, the motion characteristic feedback signal 222 is sampled at a frequency of at least two times the continuous adjustment frequency. These definitions of “continuous adjustment” apply to all embodiments and uses of this term discussed herein.

In the digital-analog hybrid control system 111, the processor 108 performs the simple calculations to produce the error signal 223 based on the reference signal and the motion characteristic feedback signal 222. These relatively simple calculations (e.g., as compared to calculations performed by the PID control of the analog control circuit 102) may be performed by a central processing unit found in conventional mobile devices, without the requirement of a dedicated and specialized digital signal processor. The analog control circuit 102 performs the more complex calculations of the PID control scheme, or any other suitable control scheme. The hardwired analog nature of the analog control circuit 102 permits the analog control circuit 102 to perform the control calculations more efficiently and in a cheaper package than a digital version.

In embodiments, the processor 108 is further configured to receive or generate an adjusted reference signal during or immediately subsequent to the performance of haptic effect. Required haptic outputs may be determined based on a user interaction with the haptically enabled device 100, and such requirements may change on an ongoing basis. The processor 108, which may operate as the central processing unit of the haptically enabled device 100, may update or adjust the reference signal as required.

In embodiments, the processor 108 is further configured to adjust characteristics of the analog control circuit 102. The analog control circuit 102 may be implemented as an integrated circuit having adjustable parameters, such as an FPGA. The processor 108 may be configured to adjust the parameters of the FPGA so as to adjust the parameters of a control scheme implemented by the analog control circuit 102. In embodiments, the processor 108 may be configured to adjust the parameters of the FPGA to correspond to one from among a plurality of predefined control schemes to be implemented by the analog control circuit 102. For example, the control scheme parameters of multiple potential FPGA programmings may be tuned to produce different control results, e.g., different gains or different damping. In embodiments, the multiple FPGA programmings may be configured for optimal performance in driving vibration actuators 105 at differing frequencies. The processor 108 may switch between the multiple FPGA programmings to select a preferred analog control circuit 102 according to the reference signal (and desired haptic effect).

In embodiments, the digital-analog hybrid control system 111 may include a plurality of analog control circuits 102. Each analog control circuit 102 may differ in control scheme parameters. For example, the control scheme parameters of multiple analog control circuits 102 may be tuned to produce different control results, e.g., different gains or different damping. In embodiments, the multiple analog control circuits 102 may be configured for optimal performance in driving vibration actuators 105 at differing frequencies. The processor 108 may switch between the multiple analog control circuits 102 to select a preferred analog control circuit 102 according to the reference signal (and desired haptic effect).

In an additional embodiment, as illustrated in FIG. 2B, a digital-analog hybrid control system 311 may employ a switch 301 to permit switching between open loop and closed loop control. The digital-analog hybrid control system 311 may include each of the same elements as the digital analog control system 111, including an analog control circuit 102, a digital control circuit 208, a vibration actuator 105, and one or more motion characteristic sensors 107. The digital-analog hybrid control system 311 further includes a switch 301 and a summation circuit 302.

The digital-analog hybrid control system 311 may operate as follows. During open loop operation, the switch 301 may be in position A. During open loop operation, the switch 301 provides a direct control path between the digital control circuit 208 and the vibration actuator 105. The digital control circuit 208 outputs a reference signal 224. During open loop operation, the reference signal 224 is the same as the command signal 221, which is received by the vibration actuator to control its output.

During closed loop operation, the switch 301 may be in position B. During closed loop operation, the switch 301 provides a path between the digital control circuit 208 and the summation circuit 302. The digital control circuit 208 provides the reference signal 224 for closed loop operation of the analog control circuit 102. The summation circuit 302 receives the reference signal 224 from the digital control circuit 208 and the motion characteristic signal 222 and outputs the error signal 223 as the difference between the reference signal 224 and the motion characteristic signal 222.

Thus, according to the digital-analog hybrid control system 311, the vibration actuator 105 may be controlled alternatively by open loop or closed loop control according to the requirements of the haptic enabled device 101.

In embodiments, the analog control circuit 102 may implement any suitable control scheme. For example, the analog control circuit 102 may implement a lead compensation controller. Lead compensation control may be advantageous when implemented with an LRA due to lag in the LRA system at resonant frequencies. When the LRA is excited at a resonant frequency, the initial frequency response demonstrates phase lag with respect to the input signal. Lead compensation control may act to counter this lag and reduce the error between the reference signal and the motion characteristic feedback signal 222. In other examples, the analog control circuit 102 may implement a proportional controller, a proportional derivative (PD) controller, a proportional integral derivative (PID) controller, a proportional integral (PI) controller, a lead-lag compensation controller, and/or any other appropriate controller.

The digital-analog hybrid control system 111 is advantageous when applied to the production of limited duration haptic effects, i.e., effects having a duration of less than 100 ms. In embodiments, limited duration haptic effects may be between 5 and 50 ms and use between 1 and 10 oscillations of the vibration actuator 105. Because of the limited duration of the haptic effects produced by embodiments hereof, the digital-analog hybrid control system 111 operates to provide continuous adjustment of the command signal 221. Such continuous adjustment means that the command signal 221 is adjusted based on the motion characteristic feedback signal 222 many times during even a very short haptic effect. In embodiments, the motion characteristic feedback signal 222 may capture motion of the vibration actuator 105 at a sampling frequency in excess of 500 Hz, in excess of 1 kHz, in excess of 5 kHz, in excess of 10 kHz, and/or in excess of 20 kHz. The processor 108 may perform updates to the error signal 223 at the same rate as the sampling frequency of the motion characteristic feedback signal 222.

In further embodiments, different portions of a digital-analog hybrid controller may be implemented in either digital or analog forms. For example, in an embodiment, the entire control loop, including the error signal, may be implemented in analog circuitry where the digital processor supplies only the reference signal to the analog portion of the control loop. In further embodiments, the digital processor may handle a larger portion of the control loop. For example, in a control system employing a PID control scheme, the digital processor may perform the steps necessary for the P (proportional control) aspects of the control scheme, while the analog circuitry is configured to perform the steps required for the I (integral control) and D (derivative control). In such embodiments, the digital processor is configured to transmit the proportional control signal to the analog control circuit as well as either or both of the error signal and the reference signal. Further embodiments may include the digital processor and the analog circuit each performing any aspects of the implemented control scheme.

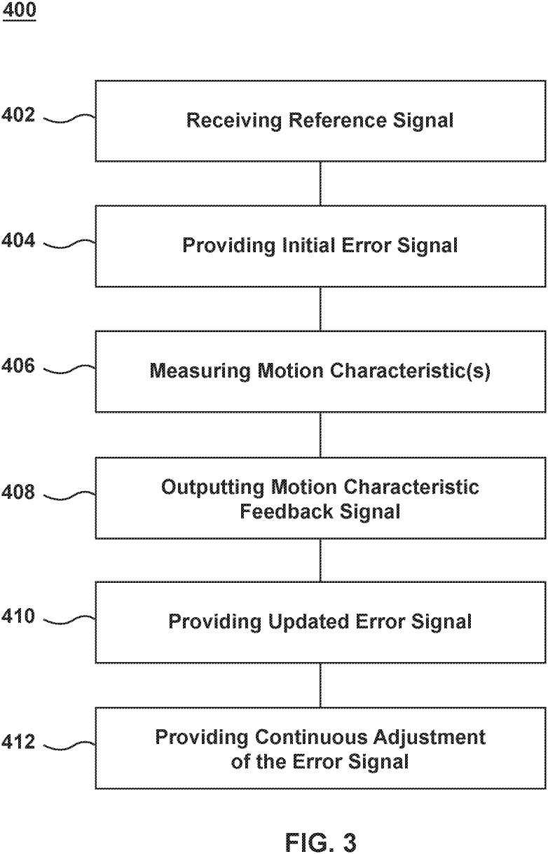

FIG. 3 depicts a flow chart showing a process 400 of providing closed-loop feedback control of a vibration actuator. The process 400 may be performed by a digital-analog hybrid control system 111 as discussed herein. As further discussed herein, any portion of a controller suitable for implementing process 400 may be implemented digitally and any portion may be implemented in analog. The closed loop feedback control implemented by process 400 may be understood as providing close tracking of a desired reference signal that may include sharp or abrupt starts and stops. For example, the process 400 may provide controlled damping to the controlled system so as to provide a sharp cut-off or abrupt stop to a haptic effect. As discussed above, closed loop feedback control may be used for only a portion of a delivered haptic effect, for example, to eliminate excess vibration at the end of a haptic effect. Such embodiments are consistent with the process 400 discussed below.

In an operation 402, the process 400 includes receiving (or generating) a reference signal. The reference signal represents a haptic effect that the haptically enabled device is attempting to produce. The goal of the process 400 is to reduce the error between the measured haptic effect, i.e., as measured by a motion characteristic feedback signal, and a haptic effect that is intended to be produced by the reference signal. Embodiments discussed herein are well suited for producing sharp haptic effects of less than 50 ms, less than 30 ms, less than 20 ms, less than 15 ms, and less than 10 ms.

In an operation 404, the process 400 includes providing an initial error signal to an analog control circuit to generate a command signal to cause the vibration actuator to deliver the limited duration haptic effect. An initial value of the error signal is selected to initiate motion of the vibration actuator and cause the limited duration haptic effect. The initial value of the error signal is determined according to the reference signal and the known characteristics of the feedback system, including at least the vibration actuator, the components that it is coupled to, and the sensor. Although feedback from the sensor will act to minimize errors between the reference signal and the motion characteristic signal (i.e., the measured haptic effect), selecting an initial error signal value close to what is necessary to achieve the desired output serves to minimize errors in the early portions of the haptic effect.

In an operation 406, the process 400 includes measuring, by a sensor, one or more motion characteristics of a haptically activated component of the haptically enabled device. In embodiments, the sensor is a motion characteristic sensor as discussed herein. Motion characteristics may include vector values such as displacement, velocity, momentum, angular velocity, angular momentum, and acceleration as well as scalar values such as speed, distance, and acceleration magnitude. The motion characteristic may be measured directly or may be derived from a directly measured value. The motion characteristic sensor may be vibrationally coupled, directly or indirectly to the vibration actuator.

In an operation 408, the process 400 includes outputting, by the sensor, a motion characteristic feedback signal indicative of the motion characteristic that is used for feedback control of the vibration actuator.

In an operation 410, the process 400 includes providing an updated error signal to the analog control circuit. The updated error signal is based on a difference between the motion characteristic feedback signal and the reference signal.

In an operation 412, the process 400 includes providing continuous adjustment of the error signal by the processor according to the motion characteristic feedback signal and the reference signal while continuously providing the command signal by the analog control circuit. The continuous adjustment of the error signal minimizes an error between the reference signal and the motion characteristic feedback signal. The motion characteristic feedback signal measures the output haptic effect and thus the continuous adjustment serves to control the vibration actuator to control the output haptic effect. The feedback system reduces and/or minimizes errors between the intended haptic effect, represented by the reference signal, and the output haptic effect, represented by the motion characteristic signal. In embodiments, continuous adjustment of the command signal is performed at a rate equaling that of the rate at which the motion characteristic feedback signal is sampled.

The above describes an illustrative flow of an example process 400 of providing closed loop control of a vibration actuator to produce limited duration haptic effects, according to embodiments described herein. The process as illustrated in FIG. 3 is exemplary only, and variations exist without departing from the scope of the embodiments disclosed herein. The steps may be performed in a different order than that described, additional steps may be performed, and/or fewer steps may be performed.

Systems and methods consistent with the closed loop control schemes described herein may permit the use of actuators having wider variance of characteristics than is conventional. As discussed above, accurate open loop control of actuators requires that the actuator characteristics fall within a narrow range. Characteristics outside of that range will result in aberrant behavior from the actuators. The use of closed loop controllers consistent with those described herein, however, permit actuators with out of specification characteristics to perform as well as actuators that are within specifications. This wider range of acceptable characteristics permits the use of less expensive actuators.

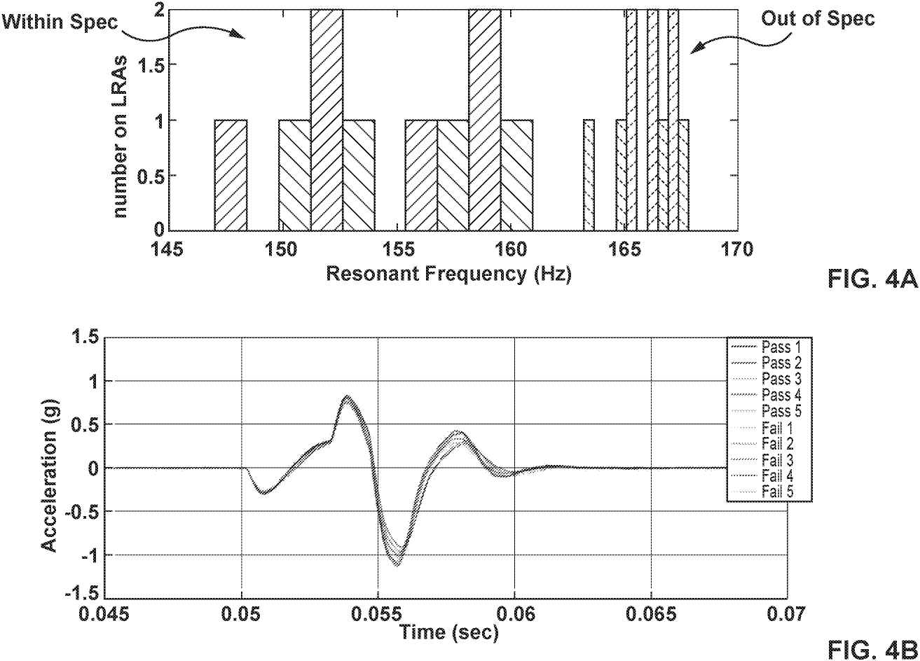

Experiments were performed on twenty LRAs, ten of which were within specification and ten of which failed quality control. FIG. 4A shows resonant frequencies of the twenty LRAs, illustrating ten within specification and ten out of specification. FIG. 4B shows the acceleration response of five LRAs within specification and 5 LRAs out of specification in producing a sharp limited duration haptic effect. These LRAs were controlled via closed loop control schemes consistent with embodiments hereof. As shown in FIG. 4B, both the in specification and out of specification LRAs showed excellent limited duration responsiveness. Thus, there are provided systems, devices, and methods of using digital-analog hybrid closed loop control systems to provide precise control of vibration actuators during limited duration haptic effects. The precise control methods enabled by embodiments herein permit the production of limited duration haptic effects having sharp or abrupt finishes. While various embodiments according to the present invention have been described above, it should be understood that they have been presented by way of illustration and example only, and not limitation. It will be apparent to persons skilled in the relevant art that various changes in form and detail can be made therein without departing from the spirit and scope of the invention. It will also be understood that each feature of each embodiment discussed herein, and of each reference cited herein, can be used in combination with the features of any other embodiment. Stated another way, aspects of the above methods of rendering haptic effects may be used in any combination with other methods described herein or the methods can be used separately. The following paragraphs describe additional aspects and embodiments of the invention.

1. A haptically enabled device, comprising:
a vibration actuator;
a sensor, configured to measure a motion characteristic of the vibration actuator, and to output a motion characteristic feedback signal;
a digital-analog hybrid control circuit comprising an analog control circuit and at least one processor, configured to control the vibration actuator to produce a limited duration haptic effect by:
generating a reference signal representing the limited duration haptic effect at the processor,
providing an error signal to the analog control circuit,
providing, by the analog control circuit, a command signal to the vibration actuator based on the error signal,
sampling the motion characteristic feedback signal, and
providing continuous adjustment of the error signal, by the processor, at the sampling frequency according to the motion characteristic feedback signal and the reference signal to cause the analog control circuit to continuously adjust the command signal to minimize an error between the reference signal and the motion characteristic feedback signal.

2. The haptically enabled device of claim 1, wherein providing continuous adjustment of the command signal is performed according to proportional derivative control.

3. The haptically enabled device of claim 1, wherein providing continuous adjustment of the command signal is performed according to lead compensation control.

4. The haptically enabled device of claim 1, wherein the vibration actuator includes at least one of a linear resonant actuator, a macrofiber composite actuator, and a piezoceramic actuator.

5. The haptically enabled device of claim 1, wherein the motion characteristic feedback signal is sampled at a sampling frequency of at least 1 kHz.

6. A method of controlling a vibration actuator by a digital-analog hybrid control circuit comprising an analog control circuit and a processor to produce a limited duration haptic effect, the method comprising:
generating, by the processor, a reference signal, the reference signal representing the limited duration haptic effect,
providing, by the processor, an initial error signal to the analog control circuit to cause the analog control circuit to generate a command signal for activating the vibration actuator;
measuring, by a sensor over time, a motion characteristic of the vibration actuator;
outputting, by the sensor, a motion characteristic feedback signal indicative of the motion characteristic; and
controlling the vibration actuator to provide the limited duration haptic effect by
sampling, by the processor, the motion characteristic feedback signal, and
providing continuous adjustment of the error signal, by the processor, at the sampling frequency according to the motion characteristic feedback signal and the reference signal while providing a command signal by the analog control circuit,
wherein providing continuous adjustment of the error signal causes the analog control circuit to continuously adjust the command signal to minimize an error between the reference and the motion characteristic feedback signal.

7. The method of claim 6, wherein providing continuous adjustment of the command signal is performed according to proportional derivative control.

8. The method of claim 6, wherein providing continuous adjustment of the command signal is performed according to lead compensation control.

9. The method of claim 6, wherein the vibration actuator includes at least one of a linear resonant actuator, a macrofiber composite actuator, and a piezoceramic actuator.

10. The method of claim 6, wherein the motion characteristic feedback signal is sampled at a sampling frequency of at least 1 kHz.
